(19) United States
(12) Patent Application Publication
(10) Pub. No.: US 2007/0174405 A1
(43) Pub. Date: Jul. 26, 2007

(54) Remote operation of instant messaging systems

(76) Inventors: Yen-Fu Chen, Austin, TX (US); John Hans Handy-Bosma, Cedar Park, TX (US); Keith Raymond Walker, Austin, TX (US); Sarah Vijoya White Eagle, Austin, TX (US)

Correspondence Address: IBM CORP (YA);C/O YEE & ASSOCIATES PC, P.O. BOX 802333, DALLAS, TX, 75380, US

(21) Appl. No.: 11/337,745

(22) Filed: Jan. 23, 2006

(51) Int. Cl. G06F 15/16

(52) U.S. Cl. 709/207

(57) ABSTRACT

A method for allowing remote operation of an instant messaging session is provided. A remote instant messaging client is selected from a list of remote instant messaging clients. User input, indicating an instant messaging command to be executed on the selected remote instant messaging client, is received. A request that includes the instant messaging command to be executed is sent to the selected remote instant messaging client. A message indicating receipt of the request by the selected remote instant messaging client is received from the selected remote instant messaging client.

### BACKGROUND OF THE INVENTION

1. Field of the Invention

The present invention relates generally to information processing systems, and more particularly, to a method and system for improved functionality within instant messaging systems.

2. Description of the Related Art

Modern computing technology has resulted in immensely complicated and ever-changing environments. One such environment is the Internet, which is also referred to as an “internetwork.” The Internet is a set of computer networks, possibly dissimilar, joined together by means of gateways that handle data transfer and the conversion of messages from a protocol of the sending network to a protocol used by the receiving network. When capitalized, the term “internet” refers to a collection of networks and gateways that use the TCP/IP suite of protocols. Currently, the most commonly employed method of transferring data over the Internet is to employ the World Wide Web environment, also called the “Web”.

The existence and continued acceptance and use of the Web and the Internet have resulted in many new and useful applications becoming available to users of the Internet. One useful and popular application that most everyone with access to the Internet uses is electronic mail (email). An email is a method of personal communication without requiring face to face contact. An email account allows a user to communicate a message to an intended email recipient. This is true even if the recipient has a different service provider than the sender. Email is based on a standard communication protocol that allows the communication of messages between individuals that may have different service providers. To correspond across the standard communications protocols using email, all that is required is the recipient's email address.

A recent advancement in the area of email and other forms of personal communication, such as web conferencing, etc., is an application, which is growing in popularity, known as “instant messaging.” Instant messaging systems are based on an architecture that usually includes at least one instant messaging server, multiple clients, and software that allows the multiple clients to communicate with each other and with the instant messaging server. A typical instant messaging exchange involves two or more users engaging in an online conversation, or chat, without the requirement of entering a message recipient's email address prior to each transmission. With instant messaging, a user sends an instant message to a recipient by typing a message on a keyboard and pressing a transmit or send button, or by simply hitting the enter key, or in the case of voice activated software, simply by speaking. In this streamlined manner, instant messaging users can chat by corresponding textually at a tempo approaching a conversational pace. Because instant messaging enables a contemporaneous textual exchange, it is now a preferred method of distance communication that has a myriad of potential uses.

While a typical instant messaging system is a single system such as AOL Instant Messenger, ICQ, Yahoo! Messenger, MSN chat, and Internet Relay Chat (IRC), some hybrid systems, such as Trillian, Fire, and Everybuddy, allow a user to send instant messages to people on various other systems from that single system. It should be understood that the present invention encompasses all of these types of systems.

Instant messaging has become an important part of both personal and business communications. At home, publicly available instant messaging clients can be used as a means of long distance communication between relatives and friends.

Instant messaging is a potentially valuable tool in the business world because decisions often must be made quickly. The popularity of instant messaging in the business place stems from the capability of a user to continuously detect the presence of others, and instantly collaborate with them online. Instant messaging also has the potential to be useful in call centers for businesses.

Various instant messaging applications are provided from many sources but all such applications have many common features. For example, these applications permit a user to chat with an individual person and, typically, there is also a feature allowing invitees to request that additional people join a chat. In general, instant messaging applications enable a user to register with an instant messaging server on the Web or other network using the Internet. Such applications may also be accessed through other local area and wide area networks as well. When a user accesses an instant messaging application, the user inputs the user's personal information together with a user identification (ID) and a password. The user is then enabled to designate a user name which will be used to identify the user in subsequent chat sessions or in sending messages to and receiving messages from other users. Instant messaging server clients can exchange text messages, audio, data and other types of multimedia files. Clients may also have a list of users called “buddy lists” that are known to them as friends, coworkers, or other user acquaintances.

As instant messaging is becoming a very valuable tool for both personal and business communications, with millions of users communicating using instant messaging systems every day, functionality and usability enhancements are important to the continued success of this communication tool. Current instant messaging applications do, however, have serious flaws and/or shortcomings which must be corrected if instant messaging is to continue to thrive as a communications vehicle.

### SUMMARY OF THE INVENTION

The present invention provides a method, computer program product and data processing system for allowing remote operation of an instant messaging session. A remote instant messaging client is selected from a list of remote instant messaging clients. User input, indicating an instant messaging command to be executed on the selected remote instant messaging client, is received. A request that includes the instant messaging command to be executed is sent to the selected remote instant messaging client. A message indicating receipt of the request by the selected remote instant messaging client is received from the selected remote instant messaging client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects of the present invention may be implemented;

FIG. 2 is a block diagram of a data processing system in which exemplary aspects of the present invention may be implemented;

FIG. 3 is a block diagram depicting typical software architecture for a server-client system in which exemplary aspects of the present invention may be implemented;

FIG. 4A-4B is a flowchart illustrating the operation of remote operation of instant messaging session, in accordance with an exemplary embodiment of the current invention;

FIG. 5 is a block diagram depicting a system for automatic detection of a user's presence and locations switching in accordance with an exemplary embodiment of the present invention; and

FIG. 6 is a table depicting the logic for executing a request by a remote launcher program in accordance with an exemplary embodiment of the present invention.

### DETAILED DESCRIPTION OF THE PREFERRED EMBODIMENT

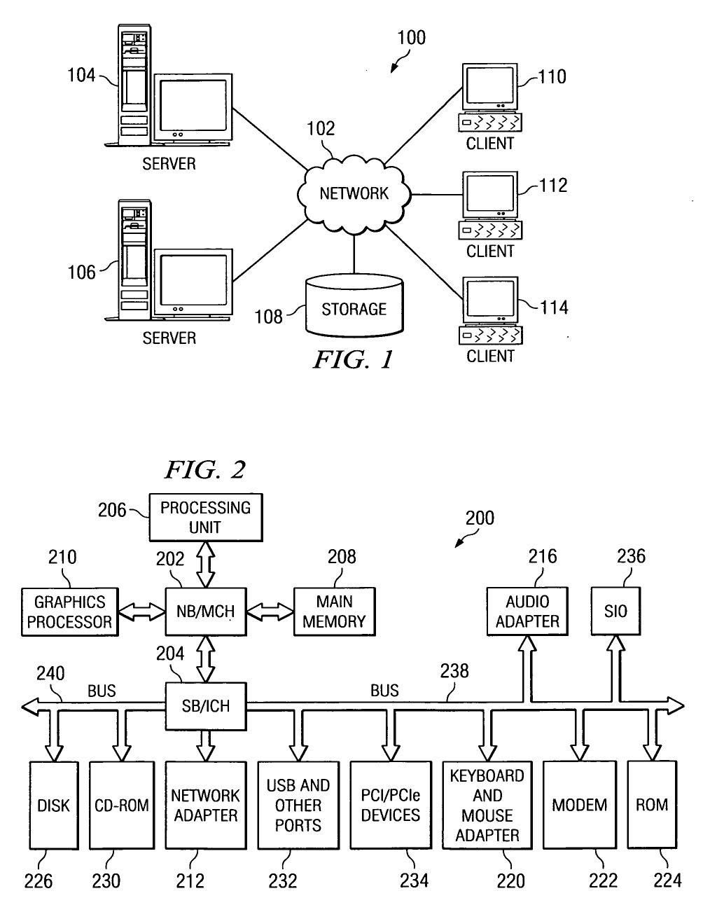

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

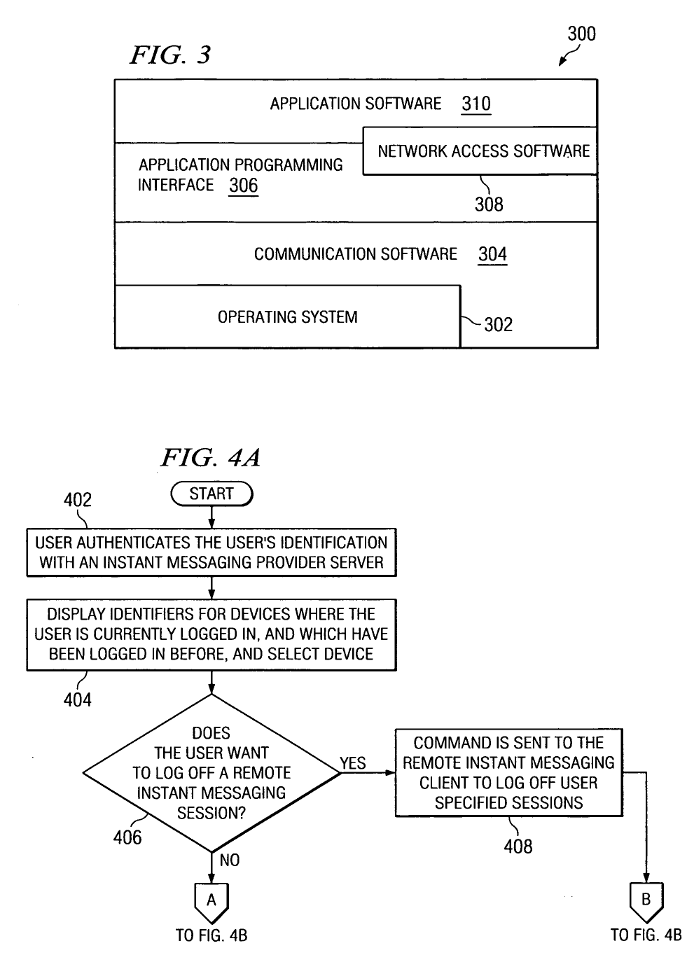

Turning to FIG. 3, typical software architecture for a server-client system is depicted in which exemplary aspects of the present invention may be implemented. At the lowest level, operating system 302 is utilized to provide high-level functionality to the user and to other software. Such an operating system typically includes a basic input output system (BIOS). Communication software 304 provides communications through an external port to a network such as the Internet via a physical communications link by either directly invoking operating system functionality or indirectly bypassing the operating system to access the hardware for communications over the network.

Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers.

Application software 310 represents any number of software applications designed to react to data through the communications port to provide the desired functionality the user seeks, such as instant messaging clients. Applications at this level may include those necessary to handle data, video, graphics, photos or text, which can be accessed by users of the Internet.

Instant messaging relies on “presence technology” where users can see whether others are on-line. Both users (initiator and receiver) must subscribe to the same service and be on-line at the same time for instant messaging to provide real-time message communication. Advanced instant messaging offers permission setting so initiator and receiver must allow participation from one another and be willing to participate in accepting messages. An attempt to send an instant message to someone who is off-line or where presence is unavailable will result in notification that transmission cannot be completed, and, in some implementations, an off-line message that the receiver will see upon next login.

A user may own and use instant messaging on more than one device, and each device may have different operating system and software applications installed. For example, a user may instant message on a Windows® notebook computer at multiple locations, an AIX® server in a lab, a Linux® desktop computer in the office, and a PalmOS® PDA. For security, performance, or simplicity of management, instant messaging providers allow only one login session at a time. Some handle initiation of multiple sessions by either denying the new session or disconnecting the old session. Instant messaging lacks the functionality of allowing remote operation of an instant messaging session.

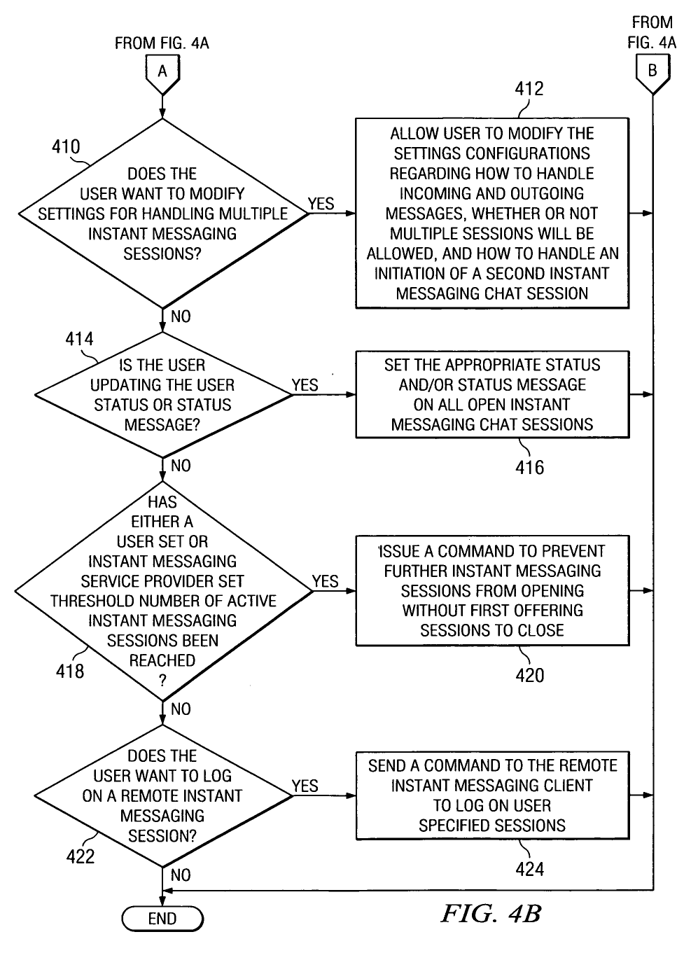

FIG. 4A-4B is a flowchart illustrating the operation of remote operation of instant messaging session, generally designated by reference number 400, in accordance with an exemplary embodiment of the current invention. The operation begins when a user authenticates the user's identification with an instant messaging provider server (step 402), which may be implemented as server 104 in FIG. 1. The operation displays identifiers for devices where the user is currently logged in, and which have been logged in before, and the user selects a device from the list (step 404). The operation determines if the user wants to log off a remote instant messaging session (step 406). If the user does want to log off a remote instant messaging session (a yes output to step 406), a command is sent to the remote instant messaging client to log off user specified sessions (step 408). The operation ends. Depending upon the particular implementation, this may include a single session, all sessions, or specific sessions, as applicable.

If the user does not want to log off a remote instant messaging session (a no output to step 406), the operation determines if the user wants to modify settings for handling multiple instant messaging sessions (step 410). If the user does want to modify settings for handling multiple instant messaging sessions (a yes output to step 410), the operation allows the user to modify the settings configurations regarding how to handle incoming and outgoing messages, whether or not multiple sessions will be allowed, and how to handle an initiation of a second instant messaging chat session step 412). The operation ends. Depending upon the particular implementation, altering the configuration of the settings may be achieved through a modification window, a set of menu driven lists, or command line syntax.

If the user does not want to modify settings for handling multiple instant messaging sessions (a no output to step 410), the operation determines if the user is updating the user status or status message (step 414). If the user is updating either the user status or status message (a yes output to step 414), the operation sets the appropriate status and/or status message on all open instant messaging chat sessions (step 416). The operation ends.

If the user is not updating either the user status or status message (a no output to step 414), the operation determines if either a user set or instant messaging service provider set threshold number of active instant messaging sessions have been reached (step 418). If either a user set or instant messaging service provider set threshold number of active instant messaging sessions has been reached (a yes output to step 418), the operation issues a command preventing further instant messaging sessions from opening without first offering sessions to close (step 420). The operation ends.

If neither a user set nor instant messaging service provider set threshold number of active instant messaging sessions have been reached (a no output to step 418), the operation determines if the user wants to log on a remote instant messaging session (step 422). If the user does want to log on a remote instant messaging chat session (a yes output to step 422), the operation sends a command to the remote instant messaging client to log on user specified sessions (step 424). The operation ends. Depending on the particular implementation, this may include a single session, all sessions, or specific sessions, as applicable. In an exemplary implementation of the present invention, the log on command includes a time element, such as log on at 12:30 pm. In another exemplary embodiment, the log on command includes rules such as auto-synchronizing instant messaging chat information. In a further exemplary embodiment the log on command includes more complex rules, such as log off other instant messaging chat sessions except the new remote instant messaging chat sessions after synchronization.

If the user does not want to log on a remote instant messaging chat session (a no output to step 422), the operation ends.

In an exemplary embodiment of the present invention, the remote instant messaging client maintains an open listing port in order to receive the remote commands. In another exemplary embodiment of the present invention a third party program that listens for the remote commands invokes the remote instant messaging client.

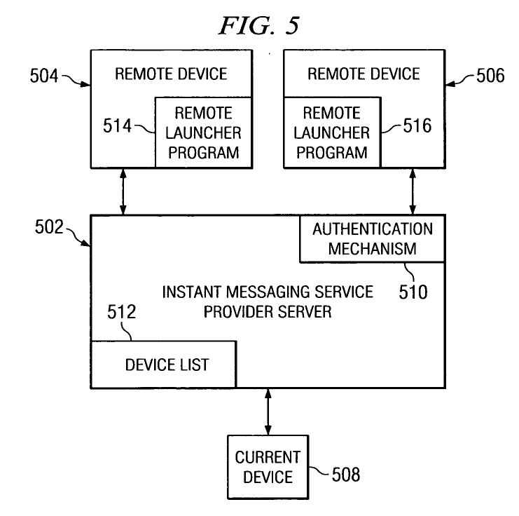

FIG. 5 is a block diagram depicting a system for automatic detection of a user's presence and locations switching in accordance with an exemplary embodiment of the present invention. Instant messaging service provider server 502, which may be implemented as server 104 in FIG. 1, acts as central gateway to manage all other devices. In the present example, only-current device 508 and two remote devices 504 and 506, are shown. However, the system may be comprised of any number of remote devices.

Remote devices 504 and 506 are any devices where a user is logged on or has logged on in the past and implemented an instant messaging chat session. A list of all remote devices and the current device is stored by instant messaging service provider server 502 in device list 512.

In an exemplary embodiment of the present invention, once the user has initially logged on to current device 508 and authenticated his/her user identification with instant messaging service provider server 502, the user does not need to log on again on other devices, as this process is handled automatically by instant messaging service provider server 502 through authentication mechanism 510. Authentication mechanism 510 authenticates the user's identification through local mechanisms, including, but not limited to, Lightweight Directory Access Protocol (LDAP), built-in authentication, authentication methods provided by runtime libraries, Secure Shell (SSH), or upon detection of network settings, functioning in a “trust mode” if the device is on the same subnet or approved IP address range. Traffic can be encrypted with certificates using Secure Socket Layer (SSL), Transport Layer Security (TSL), or other encryption protocols.

Remote launch program 514 and 516 are shown as part of remote devices 504 and 506. However, in another implementation, remote launch programs 514 and 516 may be implemented as a third party program.

In an exemplary implementation device list 512 is provided to the user as a scrollable window of device names, similar to the current contact list window in most instant messaging clients. In another exemplary implementation, device list 512 shows only devices that are controllable. In a further exemplary implementation device list 512 designates which devices in the list are controllable, such as by a bold font face, an alternate color, or icon, for example.

In an exemplary embodiment the controllability of a remote device is determined by invoking a discovery process. Depending on the particular implementation, the discovery process may be invoked at any time, such as a user designated time or frequency or a program specified time or frequency. The instant messaging service providing server sends a request to all devices in the device list for their remote launcher programs to respond with their respective status. As the remote launch programs respond with their respective status, device list 512 is updated to reflect this status.

In an exemplary embodiment, when a user desires to remotely manage an instant messaging client on one of their controllable devices, the user interacts with the device list window to indicate the user's choice. Interaction may take many forms such as double clicking the device to see a list of executable commands, or highlighting the device and then clicking a button or pressing a key to see a list of commands, or right-clicking the device to invoke a context menu of commands.

Once the device is chosen and the list of commands invoked, the user indicates which command or commands the user wants to execute. Examples of possible commands that may be invoked include, but are not limited to, connect, disconnect, set status, and set status message. In an exemplary embodiment of the present invention, in the case of instant messaging service providers that embed multiple service types, such as Trillian, which by default embeds AOL, MSN, and Yahoo, for example, the above listed commands may be separate for each service type. In an exemplary embodiment of the present invention, an option is provided to apply the chosen command to all service types.

In an exemplary embodiment of the present invention, the user may set a time to implement the request. Time may be established by either setting the number of hours, minutes, or seconds from issuance of the command to execute. Or, the user may set a specific hour, minute, and second, adjusted for the device's clock and time zone setting, for the request to be implemented.

In an exemplary embodiment of the present invention, an additional launcher program, the remote launch program, accompanies the main program. In an exemplary embodiment, the remote launcher program is installed as a “service” in Windows™ terminology or a “daemon” in LINIX™ and UNIX™ terminology. This means that remote launcher program 514 is a program that runs upon bootup of the device, and is not dependent upon user login. Remote launcher program 514 is independent of the remote instant messaging client. Remote launcher program 514 interacts with the remote instant messaging client, remote device 504. The remote instant messaging client is actually local to the remote launcher program. Remote refers to the relationship to the original instant messaging client.

The remote launcher program has three duties; (i) to listen for remote requests to interact with the remote instant messaging client; (ii) to execute requests upon the remote instant messaging client; and (iii) to report status back to the remote device that made the request.

In an exemplary embodiment of the present invention, the remote launcher program accomplishes listening for remote requests to interact with the remote instant messaging client the same way all server processes operate, by listening on a specified port number for incoming network data. Port numbers are typically configurable by the user to avoid conflicts with other programs that might use the same port numbers. Once data is received on the port, remote launcher program 514 inspects the data to make sure that the data complies with the format that remote launcher program 512 needs.

In an exemplary embodiment, in order to process the request, the request sent to the remote launcher program should include a MAC address, IP address, or other network protocol identifier of the local instant messaging client, current device 508; instant messaging login name and instant messaging login password, or other means of user authentication; request command, such as status, connect, disconnect, set status, and set status message. In another exemplary embodiment, the request includes a time to implement the request. In a further exemplary embodiment, the request includes an instant messaging service type.

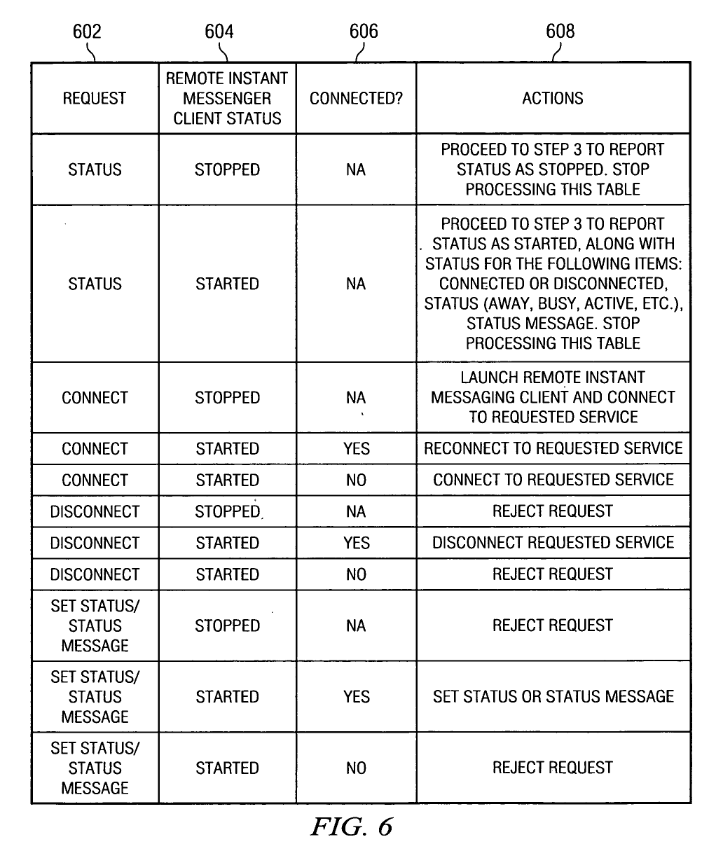

Once the request is received and passes inspection as a valid request, the remote launcher program carries out the request. In an exemplary embodiment the remote launcher program carries out the request according to the table in FIG. 6.

FIG. 6 is a table depicting the logic for executing a request by a remote launcher program in accordance with an exemplary embodiment of the present invention. Column 602, the request column, shows the possible commands contained in the request. Column 604 shows the remote instant messaging client status, either stopped or started. Column 606 shows, either as yes, no or NA, whether the remote instant messaging client is connected. Column 608 then shows what action to take. The remote launcher program reads across the table to determine how to carry out the requested command.

For example, if the request contained the command “disconnect”, the remote launcher program would check column 602 and see that there are three entry rows for “disconnect.” The remote launcher program then checks the same three rows in column 604 to find a further match. Therefore, if the remote instant messaging client status was “started”, the remote launcher program would see that the three entry rows were further narrowed to two entry rows. The remote launcher program then checks column 606 and compares the entries in the two entry rows to see which rows match the current connection status of the remote instant messaging client. If the current connection status is “yes”, the number of entry rows matching all the criteria is reduced to one. The remote launcher program would then read the corresponding entry in column 608 to see how to proceed. In the current example, the action would be to “disconnect requested service.”

After the remote launcher program receives the status from the remote instant messaging client, such as remote device 504 in FIG. 5, the remote launcher program returns this status over its listening port back to the local instant messaging client, such as current device 508 in FIG. 5. This allows the user to see if their request has been carried out. In an exemplary embodiment, the local instant messaging client may display status information in the device list, such as device list 512 in FIG. 5. Or, in another exemplary embodiment, the local instant messaging client may display status information as a status message.

Thus, an exemplary embodiment of the present invention provides the functionality of allowing remote operation of an instant messaging session.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for allowing remote operation of an instant messaging session, the computer implemented method comprising:
selecting a remote instant messaging client a list of a plurality of remote instant messaging clients;
receiving user input, wherein the user input indicates an instant messaging command to be executed on the selected remote instant messaging client;
sending a request to the selected remote instant messaging client, wherein the request includes the instant messaging command to be executed; and
receiving a status message from the selected remote instant messaging client indicating receipt of the request by the selected remote instant messaging client.

2. The computer implemented method of claim 1, wherein the instant messaging command comprises one of at least log on, log off, alter configuration settings, status, set status, and set status message.

3. The computer implemented method of claim 2, wherein the instant messaging command affects a plurality of a user's active instant messaging chat sessions.

4. The computer implemented method of claim 2, wherein the instant messaging command affects a single, active instant messaging chat session out of a plurality of a user's active instant messaging chat sessions.

5. The computer implemented method of claim 1, wherein the instant messaging command includes a single service type from a plurality of service types provided by an instant messaging service provider.

6. The computer implemented method of claim 5, wherein the instant messaging command applies to the plurality of service types provided by the instant messaging service provider.

7. The computer implemented method of claim 1, wherein the list of the plurality of remote instant messaging clients indicates which remote instant messaging clients are controllable from a remote location.

8. The computer implemented method of claim 1, wherein the instant messaging command includes a time element.

9. The computer implemented method of claim 1, wherein the instant messaging command includes a policy rule.

10. The computer implemented method of claim 1, further comprising:
receiving the request by a remote launcher program of the selected remote instant messaging client.

11. The computer implemented method of claim 10, wherein the request is first received by a third party program and the third party program passes the request on to the remote launcher program.

12. The computer implemented method of claim 10, wherein the remote launcher program executes the request.

13. The computer implemented method of claim 10, wherein the remote launcher program sends the status indication.

14. The computer implemented method of claim 10, wherein the remote launcher program is installed as a service.

15. A computer program product comprising a computer usable medium including computer usable program code for allowing remote operation of an instant messaging session, said computer program product comprising:
computer usable program code for selecting a remote instant messaging client from a list of a plurality remote instant messaging clients;
computer usable program code for receiving user input, wherein the user input indicates an instant messaging command to be executed on the selected remote instant messaging client;
computer usable program code for sending a request to the selected remote instant messaging client, wherein the request includes the instant messaging command to be executed; and
computer usable program code for receiving a status message from the selected remote instant messaging client indicating receipt of the request by the selected remote instant messaging client.

16. The computer program product of claim 15, wherein the list of the plurality remote instant messaging clients indicates which remote instant messaging clients are controllable from a remote location.

17. The computer program product of claim 15, wherein the instant messaging command includes a time element.

18. The computer program product of claim 15, wherein the instant messaging command includes a policy rule.

19. The computer program product of claim 15, further comprising:
computer usable program code for receiving the request by a remote launcher program of the selected remote instant messaging client.

20. A data processing system for allowing remote operation of an instant messaging session, said data processing system comprising:
a storage device, wherein the storage device stores computer usable program code; and
a processor, wherein the processor executes the computer usable program code to select a remote instant messaging client from a list of a plurality of remote instant messaging clients; receive user input, wherein the user input indicates an instant messaging command to be executed on the selected remote instant messaging client; send a request to the selected remote instant messaging client, wherein the request includes the instant messaging command to be executed; and receive a status message from the selected remote instant messaging client indicating receipt of the request by the selected remote instant messaging client.
